(19) United States
(12) Patent Application Publication
(10) Pub. No.: US 2018/0031754 A1
(43) Pub. Date: Feb. 1, 2018

(54) Light Guide Plate, Backlight Module And Liquid Crystal Display

(71) Applicant: Wuhan China Star Optoelectronics Technology Co., Ltd., Wuhan, Hubei (CN)

(72) Inventor: Yan CHENG, Shenzhen, Guangdong (CN)

(73) Assignee: Wuhan China Star Optoelectronics Technology Co., Ltd., Wuhan, Hubei (CN)

(21) Appl. No.: 14/910,276

(22) PCT Filed: Jan. 19, 2016
(86) PCT No.: PCT/CN2016/071369

§ 371 Date: Feb. 5, 2016

(30) Foreign Application Priority Data
Dec. 22, 2015 (CN) 201510976234.4

(51) Int. Cl. F21V 8/00

(52) U.S. Cl. CPC G02B 6/0036; G02B 6/0046; G02B 6/0058; G02B 6/005

(57) ABSTRACT

A light guide plate includes a flat plate body and multiple protrusion platforms. The flat plate body includes a top surface and a bottom surface. The multiple protrusion platforms are disposed on the bottom surface. A protrusion surface of each protrusion platform is formed by multiple pyramids. A backlight module and a liquid crystal display are also disclosed. After lights emitting from the light source and entering the light guide plate irradiates the protrusion platform, a total reflection of the lights will be broken. Accordingly, a portion of lights emit out from the top surface, the other portion of the lights emit out from the bottom surface and be reflected back to the light guide plate. The protrusion platforms can replace the mesh dot and the reflective sheet to reduce a thickness of the backlight module to increase a light utilization rate, reduce the manufacturing process and production cost.

### BACKGROUND OF THE INVENTION

### 1. Field of the Invention

The present disclosure relates to a liquid crystal display field, and more particularly to a light guide plate, backlight module and liquid crystal display.

### 2. Description of Related Art

The development trend of the market is to seek a slim portable product such as the cell phone, tablet computer, notebook, and so on that require a liquid crystal display to be thinner. Accordingly, a thickness of the liquid crystal display is also required to be thinner. In an entire liquid crystal display, except the liquid crystal panel, a backlight module constitutes a main thickness of the liquid crystal display. In order to reduce the thickness of the product, the most effective method is to make the thickness of the backlight module to be thinner.

The current backlight module can be divided into a side light type backlight module and a direct light backlight module according to different light source emitting locations. Wherein, the side light type backlight module disposes a light source such as a LED light bar at an edge of the back plate. Lights emitted from the LED light bar enters the light guide plate from a side of the light guide plate (LGP), and after reflecting and diffusing, the lights are emitted out from a light emitting surface of the light guide plate. Then, after passing through optical films, a surface light source is formed for providing lights to the liquid crystal panel.

A bottom surface of the light guide plate usually adopts concave or convex geometric mesh dots. Wherein, a uniformity of a surface light source is satisfied by adjusting the size and the density of the mesh dots. After lights emitting from the LED light bar and entering the light guide plate through the light incident surface irradiates the mesh dots, a total reflection will be broken. According, a portion of the lights will emit out from the top surface of the light guide plate, and the other portion of the lights will emit out from the bottom surface of the light guide plate and be reflected back to the light guide plate by a reflective sheet in order to increase a light efficiency. However, the reflective sheet cannot reach one hundred percent reflective efficiency so that the reflective sheet will absorb and be passed through a portion of lights so that the light utilization rate of the light guide plate is decreased, and not beneficial for a slim backlight module at the same time.

### SUMMARY OF THE INVENTION

In order to solve the above problem in the conventional art, the purpose of the present disclosure provides a light guide plate comprising: a flat plate body comprising a top surface and a bottom surface which are disposed oppositely; and multiple protrusion platforms disposed on the bottom surface; wherein, a protrusion surface of each protrusion platform is formed by multiple pyramids.

Furthermore, the light guide plate further includes: a wedge body extended along a terminal of the flat plate body, wherein, a thinner terminal surface of the wedge body is connected smoothly with a terminal of the flat plate body.

Furthermore, the multiple protrusion platforms are coated on the bottom surface.

Furthermore, the multiple protrusion platforms are made of a high reflective material.

Furthermore, along a specific direction, the number of the pyramids that form the protrusion surface is gradually increased or gradually decreased.

Another purpose of the present disclosure provides a backlight module, comprising: a light guide plate comprising a flat plate body and a wedge body extended from a terminal of the flat plate body, wherein, a thicker terminal surface of the wedge body is a light incident surface, a thinner terminal surface of the wedge body is connected smoothly with a terminal of the flat plate body, and the flat plate body comprises a light emitting surface and a bottom surface which are disposed oppositely; and multiple protrusion platforms disposed on the bottom surface, wherein, a protrusion surface of each protrusion platform is formed by multiple pyramids; and a light source is disposed adjacent to the light incident surface of the wedge body.

Furthermore, along a direction away from the light incident surface, the number of the pyramids that form the protrusion surface is gradually increased.

Furthermore, the multiple protrusion platforms are coated on the bottom surface.

Furthermore, the multiple protrusion platforms are made of a high reflective material.

Another purpose of the present disclosure provides a liquid crystal display including the backlight module described above.

The beneficial effect of the present disclosure: in the present disclosure, after the lights emitting from the light source and entering the light guide plate through the light incident surface irradiates the protrusion platform, a total reflection of the lights will be broken. Accordingly, a portion of lights will emit out from the top surface of the light guide plate, the other portion of the lights will emit out from the bottom surface of the light guide plate and be reflected back to the light guide plate. Accordingly, the protrusion platforms can replace the mesh dot and the reflective sheet in order to reduce a thickness of the backlight module in order to be beneficial for the light and thin development of the backlight module. Accordingly, the present disclosure can increase a light utilization rate of the light guide plate, reduce the manufacturing process and production cost.

### BRIEF DESCRIPTION OF THE DRAWINGS

Through following to combine figures to describe in detail, the above, the other purposes, the features and benefits of the exemplary embodiment of the present disclosure will become clearer, wherein:

FIG. 1 is a schematic structure diagram of a liquid crystal display according to an embodiment of the present disclosure;

FIG. 2 is a side view of a backlight module according to an embodiment of the present disclosure; and

FIG. 3 is a bottom view of the backlight module shown in FIG. 2.

### DETAILED DESCRIPTION OF THE PREFERRED EMBODIMENT

The following content combines with the drawings and the embodiment for describing the present invention in detail. However, many other forms can be used to implement the present invention. Besides, the present invention should not be interpreted to be limit in the specific embodiment described here. On the contrary, the embodiments provided here are used for explaining the operation principle and practical application such that person skilled in the art can under various embodiments of the present invention and various modification suitable for specific applications.

In the figures, in order to illustrate the devices clearly, thickness of the layers and regions are enlarged. A same numeral in the entire specification and figures represents a same device.

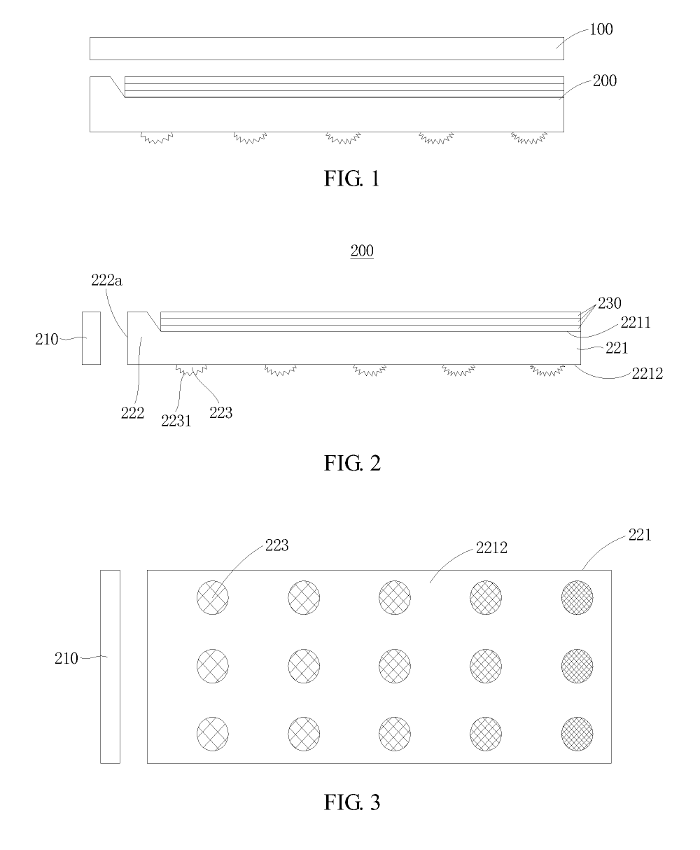

FIG. 1 is a schematic structure diagram of a liquid crystal display according to an embodiment of the present disclosure.

With reference to FIG. 1, according to an embodiment of the present disclosure, a liquid crystal display includes a liquid crystal panel 100 and a backlight module 200. Wherein, the backlight module 200 provides an even surface light source to the liquid crystal panel 100 such that the liquid crystal panel 100 can display an image.

Because the invention point of the present disclosure focus on the backlight module 200, in order to avoid repeating, the specific structure of the liquid crystal panel 100 is not described in detail anymore, person skilled in the art can refer to the specific structure of a public liquid crystal panel in the conventional art.

The following content will describe the backlight module 200 in detail. FIG. 2 is a side view of a backlight module according to an embodiment of the present disclosure, and FIG. 3 is a bottom view of the backlight module shown in FIG. 2.

With reference to FIG. 2 and FIG. 3, a backlight module 200 according to an embodiment of the present disclosure includes: a light source 210, a light guide plate 220, and optical films 230. It can be understood that the backlight module 200 can also include other necessary elements such as a back plate and a plastic frame, etc. because the invention point focus on the light guide plate 220 of the backlight module 200, the above elements are omitted selectively, and the person skilled in the art can refer to related conventional art.

The light guide plate 220 includes: a flat plate body 221, a wedge body 222 extended along a terminal of the flat plate body 221 and multiple protrusion platforms 223. Here, a thicker terminal surface of the wedge body 222 is a light incident surface 222a. A thinner terminal surface of the wedge body 222 is connected smoothly with a terminal of the flat plate body 221.

The flat plate body 221 includes a top surface 2211 and a bottom surface 2212 which are disposed oppositely. The multiple protrusion platforms 223 are distributed on the bottom surface 2212 according to a specific rule. For example, in the present embodiment, preferably, the multiple protrusion platforms 223 are distributed on the bottom surface 2212 as a matrix. Here, a protrusion surface of each protrusion platform 223 is formed by multiple pyramids 2231. However, the present disclosure is not limited. For example, the protrusion surface can be formed by multiple cylinders, multiple cubes or multiple protrusions having suitable shape.

Along a specific direction, the number of the pyramids 2231 that form the protrusion surface of the protrusion platform 223 is gradually increased or gradually decreased. In the present embodiment, preferably, along a row direction, along a direction away from the light incident surface 222a, the number of the pyramids 2231 that form the protrusion surface of the protrusion platform 223 is gradually increased. In a column direction, the number of the pyramids 2231 that form the protrusion surface of the protrusion platform 223 is the same. It should be noted that in another embodiment of the present disclosure, in the column direction, the number of the pyramids 2231 that form the protrusion surface of the protrusion platform 223 can be different.

In the present disclosure, preferably, the protrusion platform 223 is made of a high reflective material such as a barium sulfate high reflective material. However, the present disclosure is not limited. Besides, in the present disclosure, a coating process can be adopted to coat the multiple protrusion platforms 223 on the bottom surface 2212. However, the present invention is not limited. For example, a printing process can be adopted to dispose the multiple protrusion platforms 223 on the bottom surface 2212.

The light source 210 can be a light bar formed by multiple light emitting diodes (LED). However, the present disclosure is not limited. For example, the light source 210 can be a cold cathode fluorescent tube (CCFL). The light source 210 is disposed adjacent to the light incident surface 222a of the wedge body 222.

Multiple optical films 230 are disposed on the top surface 2211 for improving the optical quality of the lights emitted from the top surface 2211. In the present embodiment, the optical films 230 can include a brightness enhancement film, a diffusion film, and so on such that the optical films 230 can improve the optical quality of the light emitted from the top surface 2211.

In summary, after the lights emitting from the light source 210 and entering the light guide plate 220 through the light incident surface 222a irradiates the protrusion platform 223, a total reflection of the lights will be broken. Accordingly, a portion of lights will emit out from the top surface 2211 of the light guide plate 220, the other portion of the lights will emit out from the bottom surface 2212 of the light guide plate 220 and be reflected back to the light guide plate 220. Accordingly, the protrusion platforms 223 can replace the mesh dots and the reflective sheet in order to reduce a thickness of the backlight module 200 in order to be beneficial for the light and thin development of the backlight module 200. Accordingly, the present disclosure can increase a light utilization rate of the light guide plate 220, reduce the manufacturing process and production cost.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A light guide plate comprising:
a flat plate body comprising a top surface and a bottom surface which are disposed oppositely; and
multiple protrusion platforms disposed on the bottom surface;
wherein, a protrusion surface of each protrusion platform is formed by multiple pyramids.

2. The light guide plate according to claim 1, wherein, the light guide plate further includes: a wedge body extended along a terminal of the flat plate body, wherein, a thinner terminal surface of the wedge body is connected smoothly with a terminal of the flat plate body.

3. The light guide plate according to claim 1, wherein, the multiple protrusion platforms are coated on the bottom surface.

4. The light guide plate according to claim 1, wherein, the multiple protrusion platforms are made of a high reflective material.

5. The light guide plate according to claim 1, wherein, along a specific direction, the number of the pyramids that form the protrusion surface is gradually increased or gradually decreased.

6. The light guide plate according to claim 2, wherein, along a specific direction, the number of the pyramids that form the protrusion surface is gradually increased or gradually decreased.

7. A backlight module, comprising:
a light guide plate comprising a flat plate body and a wedge body extended from a terminal of the flat plate body, wherein, a thicker terminal surface of the wedge body is a light incident surface, a thinner terminal surface of the wedge body is connected smoothly with a terminal of the flat plate body, and the flat plate body comprises a light emitting surface and a bottom surface which are disposed oppositely;
multiple protrusion platforms disposed on the bottom surface, wherein, a protrusion surface of each protrusion platform is formed by multiple pyramids; and
a light source is disposed adjacent to the light incident surface of the wedge body.

8. The backlight module according to claim 7, wherein, along a direction away from the light incident surface, the number of the pyramids that form the protrusion surface is gradually increased.

9. The backlight module according to claim 7, wherein, the multiple protrusion platforms are coated on the bottom surface.

10. The backlight module according to claim 8, wherein, the multiple protrusion platforms are coated on the bottom surface.

11. The backlight module according to claim 7, wherein, the multiple protrusion platforms are made of a high reflective material.

12. The backlight module according to claim 8, wherein, the multiple protrusion platforms are made of a high reflective material.

13. A liquid crystal display, comprising a liquid crystal panel and a backlight module, wherein, the backlight module comprises:
a light guide plate comprising a flat plate body and a wedge body extended from a terminal of the flat plate body, wherein, a thicker terminal surface of the wedge body is a light incident surface, a thinner terminal surface of the wedge body is connected smoothly with a terminal of the flat plate body, and the flat plate body comprises a light emitting surface and a bottom surface which are disposed oppositely;
multiple protrusion platforms disposed on the bottom surface, wherein, a protrusion surface of each protrusion platform is formed by multiple pyramids; and
a light source is disposed adjacent to the light incident surface of the wedge body.
